(19) United States
(12) Patent Application Publication
(10) Pub. No.: US 2020/0034195 A1
(43) Pub. Date: Jan. 30, 2020

(54) NETWORK-RELATED PERFORMANCE FOR GPUS

(71) Applicant: Advanced Micro Devices, Inc., Santa Clara, CA (US)

(72) Inventors: Michael W. LeBeane, Austin, TX (US); Khaled Hamidouche, Austin, TX (US); Bradford M. Beckmann, Bellevue, WA (US)

(73) Assignee: Advanced Micro Devices, Inc., Santa Clara, CA (US)

(21) Appl. No.: 16/049,216

(22) Filed: Jul. 30, 2018

(51) Int. Cl. G06F 9/48; G06F 9/50; G06F 9/54

(52) U.S. Cl. CPC G06F 9/4881; G06F 9/541; G06F 9/5083

(57) ABSTRACT

Techniques for improved networking performance in systems where a graphics processing unit or other highly parallel non-central-processing-unit (referred to as an accelerated processing device or “APD” herein) has the ability to directly issue commands to a networking device such as a network interface controller (“NIC”) are disclosed. According to a first technique, the latency associated with loading certain metadata into NIC hardware memory is reduced or eliminated by pre-fetching network command queue metadata into hardware network command queue metadata slots of the NIC, thereby reducing the latency associated with fetching that metadata at a later time. A second technique involves reducing latency by prioritizing work on an APD when it is known that certain network traffic is soon to arrive over the network via a NIC.

This invention was made with Government support under PathForward Project with Lawrence Livermore National Security (Prime Contract No. DE-AC52-07NA27344, Subcontract No. B620717) awarded by DOE. The Government has certain rights in this invention.

### BACKGROUND

Graphics processing units (“GPUs”) are massively parallel computing devices that are useful for a wide variety of tasks. The total processing capacity applied to any particular computing task can be increased through the use of networked computing devices each including a GPU. To facilitate such configurations, improvements to the interoperation between GPUs and network interface controllers are being made.

### BRIEF DESCRIPTION OF THE DRAWINGS

A more detailed understanding may be had from the following description, given by way of example in conjunction with the accompanying drawings wherein:

FIG. 1A is a block diagram illustrating details of a computer system that can be included in a network, according to an example;

FIG. 1B is a block diagram of the computer system of FIG. 1A, illustrating additional details related to the accelerated processing device, according to an example;

FIG. 1C is a block diagram of an example networked computer system;

FIG. 2 illustrates an example method for pre-fetching network queue metadata into a network interface controller; and

FIG. 3 is a flow diagram of a method for prioritizing work to be executed on an accelerated processing device, according to an example.

### DETAILED DESCRIPTION

Techniques for improved networking performance in systems where a graphics processing unit or other highly parallel non-central-processing-unit (referred to as an accelerated processing device or “APD” herein) has the ability to directly issue commands to a networking device such as a network interface controller (“NIC”) are disclosed.

According to a first technique, the latency associated with loading certain metadata into NIC hardware memory is reduced or eliminated. More specifically, a NIC is able to execute commands from many independent network command buffers. In order for a NIC to execute network commands from a network command buffer, the NIC must have metadata for the network command buffer, including, for example, network command buffer location, network command buffer size, and other information, for that network command buffer. The metadata for all network command buffers is stored in general system memory but for speed, the NIC also stores local copies of that metadata for a limited number of network command buffers. If the NIC is instructed to execute network commands from a network command buffer for which the NIC does not locally store the metadata, then the NIC must read that metadata from system memory into local memory before executing the network commands. It is possible for different work executing in the APD to utilize different network command buffers. Thus, it is possible that when some network commands execute on the APD, the metadata for the network command buffer for the network commands is not loaded into the NIC, resulting in latency associated with loading that metadata into the NIC. The first technique is a prefetching technique by which certain actions on the APD trigger a pre-fetch of network command buffer metadata to reduce or eliminate this latency. Specific actions that result in such a pre-fetch are discussed in further detail herein.

A second technique involves reducing latency by prioritizing work on an APD when it is known that certain network traffic is soon to arrive over the network via a NIC. A brief example is provided in the context of a system including a first device and a second device, each including a NIC, where the NICs are connected to each other via a network. In this system, the first device includes an APD 116. The first device detects a NIC command prediction that predicts that the first device is likely to transmit data to the second device via the network soon. In response to this detection, the first device transmits an indication of this prediction to the second device via the network. In response, the second device performs either or both of: 1) preparing its own NIC to receive the data that will come soon, which reduces the latency associated with receiving that data; or 2) prioritizing work on its APD so that work that is dependent on the data that will be received soon will execute earlier than if the prioritization had not occurred.

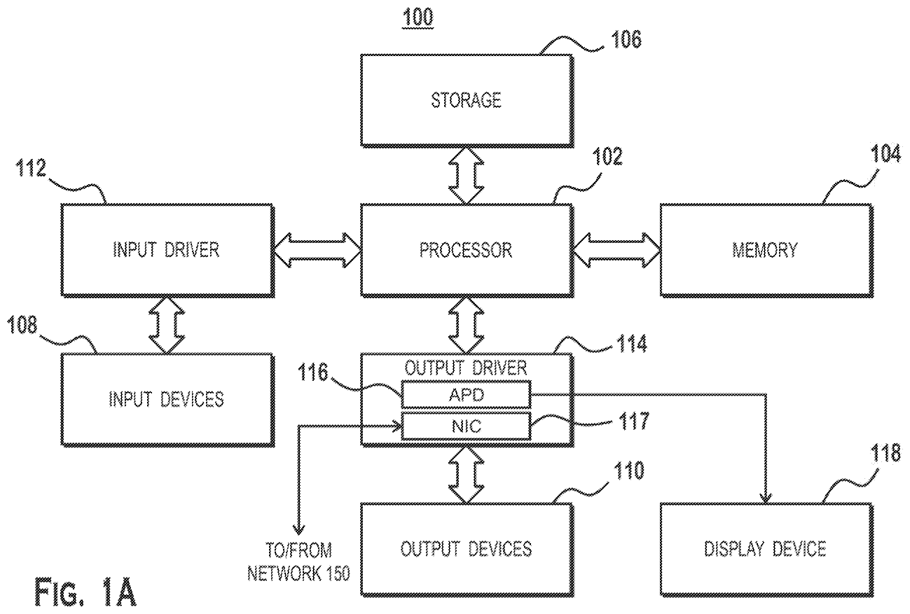

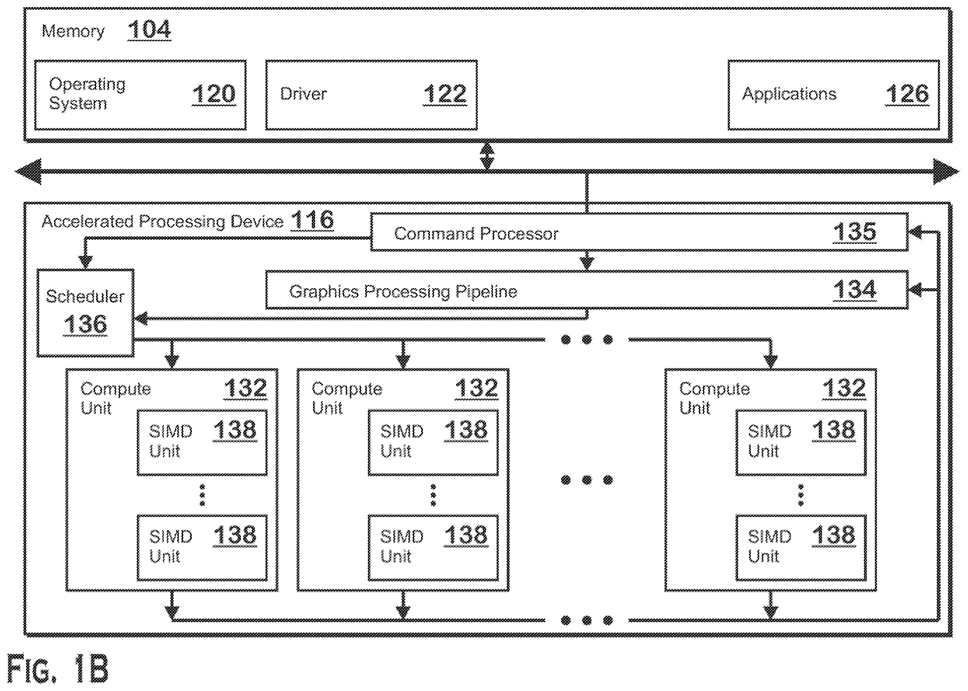

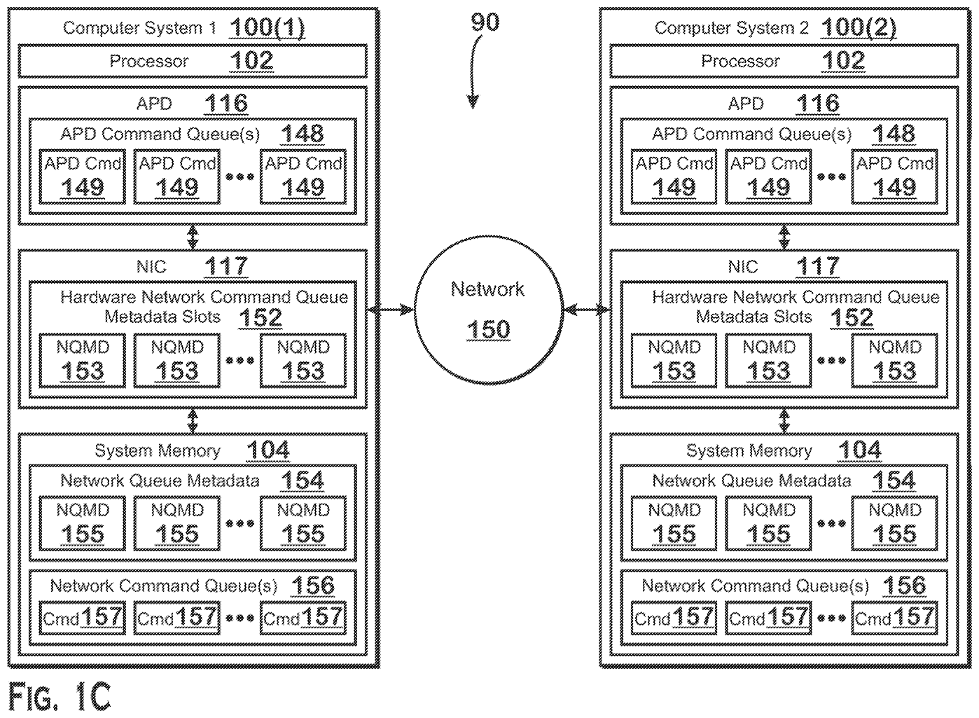

FIG. 1A is a block diagram illustrating details of a computer system 100 that can be included in a network, according to an example. The computer system 100 includes, for example, a computer, a gaming device, a handheld device, a set-top box, a television, a mobile phone, or a tablet computer. The computer system 100 includes a processor 102, a memory 104, a storage device 106, one or more input devices 108, and one or more output devices 110. The computer system 100 also includes an input driver 112 and an output driver 114. It is understood that the device 100 may include additional components not shown in FIG. 1A.

The processor 102 includes a central processing unit (CPU), a graphics processing unit (GPU), a CPU and GPU located on the same die, or one or more processor cores, wherein each processor core may be a CPU or a GPU. The memory 104 is located on the same die as the processor 102, or may be located separately from the processor 102. The memory 104 includes a volatile or non-volatile memory, for example, random access memory (RAM), dynamic RAM, or a cache.

The storage device 106 includes a fixed or removable storage, for example, a hard disk drive, a solid state drive, an optical disk, or a flash drive. The input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (APD) 116 which is coupled to a display device 118. The APD is configured to accept compute commands and graphics rendering commands from processor 102, to process those compute and graphics rendering commands, and to provide pixel output to display device 118 for display. The techniques described herein could also be performed by an APD 116 that does not have graphics rendering capability. The output driver 114 also includes a NIC 117 which is coupled to a network 150.

FIG. 1B is a block diagram of the computer system 100, illustrating additional details related to the APD 116, according to an example. The processor 102 maintains, in system memory 104, one or more control logic modules for execution by the processor 102. The control logic modules include an operating system 120, a driver 122, and applications 126, and may optionally include other modules not shown. These control logic modules control various aspects of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a compiler that compiles shader code into shader programs for execution by processing components (such as the SIMD units 138 discussed in further detail below) of the APD 116. A command processor 135 receives commands from the processor 102 (or other source) and executes those commands on the APD 116. The commands include, without limitation, commands to perform graphics rendering tasks using the graphics processing pipeline 134, commands to execute shader programs on the compute units 132 via the scheduler 136, and commands to issue networking commands to the NIC 117.

The APD 116 executes commands and programs for selected functions, such as graphics operations and non-graphics operations, which may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102 or that are not part of the “normal” information flow of a graphics processing pipeline, or that are completely unrelated to graphics operations (sometimes referred to as “GPGPU” or “general purpose graphics processing unit”).

The APD 116 includes compute units 132 (which may collectively be referred to herein as “programmable processing units”) that include one or more SIMD units 138 that are configured to perform operations in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by individual lanes, predication of lanes corresponding to control flow paths not currently being executed, and serial execution of different control flow paths, allows for arbitrary control flow to be followed.

The basic unit of execution in compute units 132 is a work-item. Each work-item represents a single instantiation of a shader program that is to be executed in parallel in a particular lane of a wavefront. Work-items can be executed simultaneously as a “wavefront” on a single SIMD unit 138. Multiple wavefronts may be included in a “work group,” which includes a collection of work-items designated to execute the same program. A work group can be executed by executing each of the wavefronts that make up the work group. The wavefronts may be executed sequentially on a single SIMD unit 138 or partially or fully in parallel on different SIMD units 138. Wavefronts can be thought of as instances of parallel execution of a shader program, where each wavefront includes multiple work-items that execute simultaneously on a single SIMD unit 138 in line with the SIMD paradigm (e.g., one instruction control unit executing the same stream of instructions with multiple data). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, tessellation, geometry shading operations, and other graphics operations. A graphics processing pipeline 134 which accepts graphics processing commands from the processor 102 thus provides computation tasks to the compute units 132 for execution in parallel.

The compute units 132 are also used to perform computation tasks not related to graphics or not performed as part of the “normal” operation of a graphics processing pipeline 134 (e.g., custom operations performed to supplement processing performed for operation of the graphics processing pipeline 134). An application 126 or other software executing on the processor 102 transmits programs (often referred to as “compute shader programs,” which may be compiled by the driver 122) that define such computation tasks to the APD 116 for execution. Although the APD 116 is illustrated with a graphics processing pipeline 134, the teachings of the present disclosure are also applicable for an APD 116 without a graphics processing pipeline 134.

In addition, shader programs executed on the compute units 132 may include networking commands. For example, such programs may include commands to send or receive data via a NIC 117. When executed, these commands are executed by the NIC 117 without intervention by the processor 102.

FIG. 1C is a block diagram of an example networked system 90. The networked system 90 is illustrated as including two computer systems 100 although it should be understood that more than two computer systems could be included in the network system 90 and that each computer system may have different or the same components as one or more other computer systems. The networked system 90 includes a first computer system 100(1) and a second computer system 100(2). Each computer system 100 includes a network interface controller (“NIC”) 117. The first computer system 100(1) includes an accelerated processing device (“APD”) 116 and the second computer system 100(2) optionally includes an APD 116. The first computer system 100(1) is in communication with the second computer system 100(2) via the network 150, which can be any technically feasible computer network.

Each NIC 117 includes hardware network command queue metadata slots 152, which store multiple network queue metadata entries 153. Each of these network command queue metadata entries 153 stores information about a particular network command queue 156. This information includes the location in memory of the network command queue 156, the size of the network command queue 156, and other information that allows the NIC 117 to read the network command queue 156 and execute the network commands 157 therein. System memory 104 of each computer system 100 includes network queue metadata 154, which includes multiple network queue metadata entries 155, each of which stores similar information as the network command queue metadata 153, but acts as a larger pool from which the NIC 117 may read if necessary. The system memory 104 of each computer system 100 also includes multiple network command queues 156, each of which stores multiple network commands 157 for execution by the NIC 117. These network commands 157 may include commands such as commands to send data to computer system 2 100(2) and to receive data from computer system 2 100(2).

In operation, the command processor 135 of the APD 116 executes APD commands 149 from one or more APD command queues 148. These APD commands 149 include, for example, and without limitation, commands to render images using the graphics processing pipeline 134, commands to execute shader programs on the compute units 132, and/or commands to request that the NIC 117 execute network commands such as commands for transmitting or receiving data over the network 150. Each APD command queue 148 includes a stream of commands to execute for a particular client. It is possible for there to be more APD command queues 148 than the number that can be executed concurrently by the APD 116. Thus, at any particular time, the APD 116 may be executing APD commands 149 from an active set of one or more APD command queues 148, while not executing APD commands 149 from an inactive set of one or more APD command queues 148. The APD 116 is capable of converting an active APD command queue 148 to an inactive command queue 148 and an inactive command queue 148 to an active command queue 148, in response to various triggers. In one example, the APD 116 cycles through the command queues 148 in a time-wise manner, providing time-wise sharing of the hardware resources to the different APD command queues 148. In another example, a software client with high authority such as the operating system 120 or the driver 122 explicitly requests that a particular APD command queue 148 be made active or inactive. Any other technically feasible trigger for activating or inactivating an APD command queue 148 is possible as well.

In operation, the APD 116 sometimes issues network commands, such as commands to transmit data to the second computer system 100(2), directly to the NIC 117 without the intervention of the processor 102. More specifically, in traditional system architectures, the APD 116 does not issue commands to the NIC 117. Instead, in such traditional architectures, the processor 102 issues commands to the NIC 117 in response to specific work being complete in the APD 116. For instance, in such traditional system architectures, the processor 102 might issue work to the APD 116 to render a frame. Once the frame is rendered, the APD 116 notifies the processor 102 that the frame is rendered. In this traditional system architecture, to transmit the frame to computer system 2 100(2), the processor 102 obtains the frame rendered by the APD 116 and instructs the NIC 117 to transmit that frame to computer system 2 100(2). Thus, in the traditional system architecture, the processor 102 coordinates activity on the APD 116 with activity on the NIC 117 in order to facilitate network communication of APD-related data via the NIC 117. According to the techniques of the present disclosure, however, the APD 116 is capable of directly issuing commands to the NIC 117. For instance, in the system of the present disclosure, the APD 116 may directly issue a command to the NIC 117 to transmit a rendered frame to computer system 2 100(2), and the NIC 117 executes that command.

The APD 116 issues network commands in the following manner. First, the APD 116 writes the network commands into a network command queue 156. Then, the APD 116 notifies the NIC 117 that there are commands in the network command queue 156. If the hardware network command queue metadata slots 152 stores a network queue metadata entry 153 identifying the network command queue 156 at issue, then the NIC 117 reads that network queue metadata entry 153 to locate the network command queue 156. Then, the NIC 117 reads the commands from the network command queue 156 and executes those commands. In the hardware network command queue metadata slots 152 do not store a network queue metadata entry 153 identifying the network command queue 156 at issue (the one to which the commands were written by the APD 116), then the NIC 117 first reads the network queue metadata 154 in system memory 104 to identify the particular network queue metadata entry 155 associated with the network command queue 156 at issue. The NIC 117 loads that network queue metadata entry 155 into a hardware network command queue metadata slot 152. At that point, the NIC 117 uses the network queue metadata entry 153 now loaded into the NIC 117 to read the network command queue 156 at issue and to execute the commands stored in that network command queue 156. Thus, when the APD 116 requests the NIC 117 perform a command from a network command queue 156 for which network queue metadata is not loaded into the NIC 117, an amount of latency is incurred that results from the NIC 117 reading the network queue metadata from system memory 104 before being able to read and execute the network command. Thus it is better for network queue metadata to be present in the NIC 117 when the NIC 117 receives a request to execute a command in a network command queue 156 using that network queue metadata.

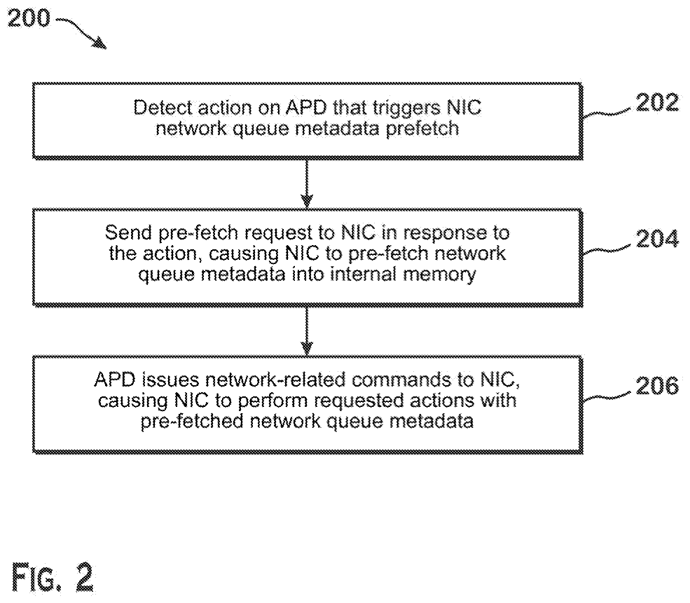

Thus, FIG. 2, which will be discussed in conjunction with at least FIG. 1C, illustrates an example method 200 for pre-fetching network queue metadata into the NIC 117 prior to the APD 116 issuing network commands. Although described in the context of the system of FIGS. 1A-1C, it should be understood that any system that performs the steps of FIG. 2 in any technically feasible order falls in the scope of the present disclosure.

The method 200 begins at step 202, where an APD 116 detects an action that triggers a pre-fetch of the network command queue metadata into one of the hardware network command queue metadata slots 152. There are a number of possible such actions that can trigger such a pre-fetch. One example pre-fetch triggering action is that the APD 116 makes a particular APD command queue 148 active. More specifically, the APD 116 associates different APD command queues 148 with different network command queues 156. This association represents an indication that a particular APD command queue 148 is known to use a particular network command queue 156 for executing network commands. For example, it may be known that a particular APD command queue 148 contains commands to be executed by the APD 116 to issue commands to the NIC 117 using a particular network command queue 156. Thus that APD command queue 148 would be marked as associated with that particular network command queue 156. The association between network command queues 156 may be explicitly specified by an application or other software that issues the commands to the APD 116 or may be made by the driver 122, command processor 135, or other entity pre-scanning the commands issued by the processor 102 to determine that the commands utilize a particular network command queue 156.

Another example pre-fetch triggering action is detecting an instruction or command on the APD 116 to issue a network command from the APD 116 to the NIC 117. This detection can occur prior to or in parallel with the actual execution of the command. This network command specifies or is associated with a particular network command queue 156. Thus the APD 116 is able to request the NIC 117 to pre-fetch the associated network queue metadata into the hardware network command queue metadata slot 152 for the detected instruction or command to issue the network command from the APD 116. In an example, a particular shader program to be executed on the APD 116 includes an instruction to cause the NIC 117 to execute a send command over the network 150. Detecting that the shader program to be executed includes such an instruction is an example of a pre-fetch triggering action.

Yet another example pre-fetch triggering action is to use explicit pre-fetch commands. These pre-fetch commands may be submitted to the APD 116 from other software such as an application 126 or the driver 122 executing on the processor 102 or by software executing in the APD 116 itself. In an example, an application 126 executing on the processor 102 submits to the APD 116 a command to pre-fetch a particular network queue metadata into the hardware network command queue metadata slots 152 as well as other commands including a network command stored in the associated network command queue 156. Then, the APD 116 executes the command to pre-fetch the network queue metadata, which would cause the NIC 117 to pre-fetch that metadata, and executes the other commands including the network command. With the network queue metadata pre-fetched into the NIC 117, the NIC 117 would not experience the above-described latency when executing the network command issued by the APD 116.

At step 204, in response to the pre-fetch triggering action, the APD 116 sends a pre-fetch request to the NIC 117. The pre-fetch request specifies a particular network command queue 156. In response to the pre-fetch request, the NIC 117 pre-fetches the network queue metadata for the specified network command queue 156 into the hardware network command queue metadata slot 152.

At step 206, the APD 116 issues network-related commands to the NIC 117. This issuance is done by writing the command to the appropriate network command queue 156 and transmitting an indication to the NIC 117 that commands are available to be executed in that network command queue 156. These network-related commands include, for example, a command to transmit data via the NIC 117 over the network 150. In response the indication that commands are available in the network command queue 156, the NIC 117 locates the appropriate network command queue 156 using the pre-fetched network command queue metadata. The NIC 117 then reads the network command written into the network command queue 156 and executes that network command. Note that although the network command queue metadata 154 and network command queues 156 are described as being stored in system memory 104, it is possible for these elements to be stored in memory other than the system memory 104.

In addition to reducing latency for executing network commands, it is also possible to use the predictions that network commands are about to be executed by an APD 116 to prioritize work on a remote APD 116. “Local” means the computing device 100 on which the prediction is made and “remote” means a different computing device 100 than the computing device 100 on which the prediction is made.

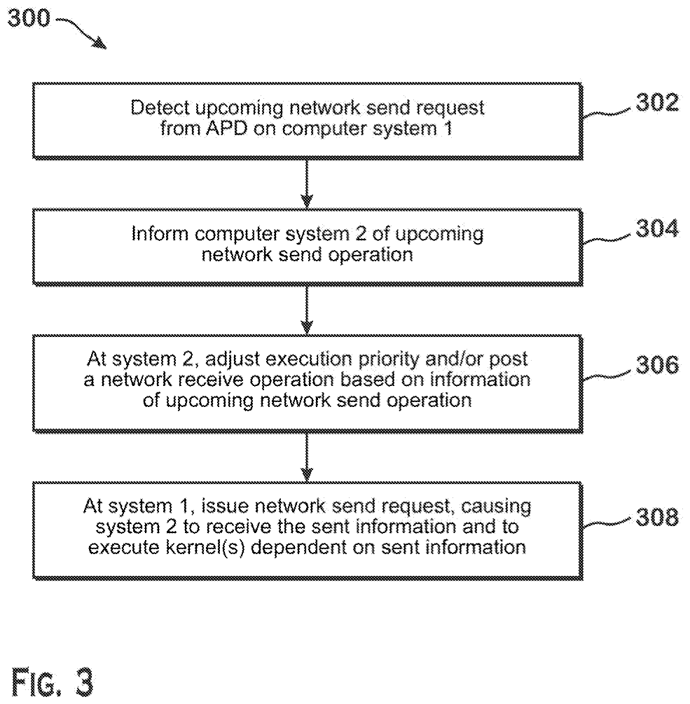

FIG. 3, which will be discussed in conjunction at least with FIG. 1C, is a flow diagram of a method 300 for prioritizing work to be executed on an APD 116, according to an example. Although described in the context of the system of FIGS. 1A-1C, it should be understood that any system that performs the steps of FIG. 3 in any technically feasible order falls in the scope of the present disclosure.

The method 300 begins at step 302, where an APD 116 on computer system 1 100(1) detects an upcoming network send request. This prediction is made in any of the ways for detecting the action that triggers a pre-fetch in the method of FIG. 2. More specifically, the APD 116 detects a send by performing one of: detecting a switch of an APD command queue 148 from inactive to active, where the APD command queue 148 is associated with a particular network command queue 156; detecting that the APD 116 is about to execute a network send command targeting computer system 2 100(2) by examining the APD commands or shader instructions directly, or by executing a command that explicitly informs the APD 116 that a network send command targeting computer system 2 100(2) is about to be executed.

At step 304, in response to the prediction, the APD 116 on computer system 1 100(1) transmits a notification to computer system 2 100(2) that computer system 1 100(1) will soon transmit data, to computer system 2 100(2), that will be used by the APD 116 of computer system 2 100(2).

At step 306, in response to receiving the notification that computer system 1 100(1) will soon transmit data that will be used by the APD 116, the APD 116 at computer system 2 100(2), the APD 116 at computer system 2 100(2) adjusts the execution priority and/or posts a network receive operation based on the notification of the upcoming network send operation. Adjusting the execution priority includes increasing the execution priority of one or both the following types of work, where increasing the execution priority of the work involves causing that work to be executed earlier than if the increase in execution priority had not been made. A first type of work whose execution priority is increased is called “directly dependent work.” Directly dependent work is work that directly uses (e.g., inputs and performs operations based on) the data that will be transmitted. A second type of work whose execution priority is increased is work that the directly dependent work depends on. In one example, a first shader program on computer system 2 100(2) that uses the transmitted data is considered the directly dependent work. This first shader program is thus directly dependent on the transmitted data. However, the first shader program also uses information generated by a second shader program. This second shader program is the second type of work whose execution priority is increased. The priority of this work is increased because the directly dependent work can only execute once the second type of work has executed.

In addition to, or alternative to, adjusting the execution priority of the above mentioned work, at step 306, computer system 2 100(2) posts a network receive operation based on the information indicating that computer system 1 100(1) will soon send data to computer system 2 100(2). Posting the receive operation is an instruction to the NIC 117 to expect to receive particular data. This post operation informs the NIC 117 of the location of a buffer to place the data in. Without this post operation, the NIC 117 may be unready to receive the data and may either discard the data or place the data into an intermediate buffer, from which the data later needs to be copied into an appropriate target buffer. Thus posting the receive operation in response to receiving the notification that data will soon be sent from computer system 1 100(1) improves the performance associated with receiving the data from computer system 1 100(1). An example of posting a receive operation is the MPI_Recv receive operation of the message passing interface (“MPI”) standard.

At step 308, computer system 1 100(1) issues the network send request, which causes the NIC 117 at computer system 1 100(1) to transmit the data to computer system 2 100(2). Because the work at computer system 2 100(2) that is dependent on this transmitted data had its execution priority increased, this dependent work can execute earlier than if the execution priority was not increased in response to the notification from computer system 1 100(1).

The above description of FIG. 3 describes a send-prediction mechanism. It is possible for the method 300 to also be applied in a receive-prediction configuration. More specifically, the APD 116 on one computer system 100 predicts that a receive operation is about to occur. This prediction can occur in the same manner as with predicting that the send operation is about to occur, as described above. Once predicted, the APD 116 transmits a notification (a “receive prediction notification”) to APD 116 in the computer system 100 from which the data is to be received. In response to the notification, the APD 116 in the computer system 100 from which the data is to be received prioritizes (i.e., increases the execution priority) the work that includes the send operation at issue as well as any work upon which that work is dependent. This prioritization causes the data to be sent to the computer system 100 sending the receive prediction notification earlier than if such prioritization had not occurred.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for improving network-related performance for accelerated processing devices (“APDs”), the method comprising:
predicting that a networking command is to be executed on a first APD; and
responsive to the predicting, performing one or more operations to improve networking-related performance.

2. The method of claim 1, wherein predicting that the networking command is to be executed on the first APD includes one or more of: detecting activation of an APD command queue, detecting scheduling of a networking command on the first APD, or executing a command on the APD explicitly indicating that the networking command is to be executed.

3. The method of claim 2, wherein the APD command queue is included in a set of APD command queues, each of which are either active or inactive on the first APD, wherein the first APD executes commands from active APD command queues but not from inactive APD command queues.

4. The method of claim 1, wherein improving networking-related performance includes improving performance of a network interface controller (“NIC”) in the same computer system as the APD.

5. The method of claim 4, wherein improving network-related performance of the NIC comprises pre-fetching network queue metadata into hardware slots of the NIC.

6. The method of claim 1, wherein improving networking-related performance includes:
improving performance of a second APD that is remote to the first APD,
wherein the first APD is communicatively coupled to a first NIC, the second APD is communicatively coupled to a second NIC, and the first APD is communicatively coupled to the second APD through the first NIC and the second NIC.

7. The method of claim 6, wherein:
the network command comprises a network send command to transmit data from the first APD to the second APD; and
improving performance of the second APD comprises increasing execution priority of work on the second APD that is dependent on the data to be transmitted from the first APD to the second APD.

8. The method of claim 6, wherein:
the network command comprises a network send command to transmit data from the first APD to the second APD; and
improving performance of the second APD comprises posting a receive operation instructing the second NIC to expect to receive the data from the first APD.

9. The method of claim 1, wherein improving networking-related performance includes:
improving performance of the first APD, wherein the first APD is communicatively coupled to a first NIC, a second APD is communicatively coupled to a second NIC, and the first APD is communicatively coupled to the second APD through the first NIC and the second NIC,
wherein the network command comprises a network receive command to receive data at the first APD from the second APD, and
wherein improving performance of the first APD comprises increasing execution priority of work on the second APD related to sending the data that is to be received at the first APD.

10. A computer system for improving network-related performance for accelerated processing devices (“APDs”), the computer system comprising:
a first network interface controller (“NIC”); and
a first APD,
wherein the first APD is configured to:
predict that a networking command is to be executed on a first APD for the first NIC; and
responsive to the predicting, performing one or more operations to improve networking-related performance.

11. The computer system of claim 10, wherein the first APD is configured to predict that the networking command is to be executed on the first APD by performing one or more of:
detecting activation of a first APD command queue;
detecting scheduling of a networking command on the first APD; or
executing a command on the first APD explicitly indicating that the networking command is to be executed.

12. The computer system of claim 11, wherein the first APD command queue is included in a set of APD command queues, each of which are either active or inactive on the first APD, wherein the first APD executes commands from active APD command queues but not from inactive APD command queues.

13. The computer system of claim 10, wherein the first APD is configured to improve networking-related performance by:
improving performance of a network interface controller (“NIC”) in the same computer system as the first APD.

14. The computer system of claim 13, wherein the first APD is configured to improve networking-related performance by:
triggering pre-fetch of network queue metadata into hardware slots of the NIC.

15. The computer system of claim 10, wherein the first APD is configured to improve networking-related performance by:
improving performance of a second APD that is remote to the first APD,
wherein the first APD is communicatively coupled to a first NIC, the second APD is communicatively coupled to a second NIC, and the first APD is communicatively coupled to the second APD through the first NIC and the second NIC.

16. The computer system of claim 15, wherein:
the network command comprises a network send command to transmit data from the first APD to the second APD; and
the first APD is configured to improve performance of the second APD by increasing execution priority of work on the second APD that is dependent on the data to be transmitted from the first APD to the second APD.

17. The computer system of claim 15, wherein:
the network command comprises a network send command to transmit data from the first APD to the second APD; and
the first APD is configured to improve performance of the second APD comprises posting a receive operation instructing the second NIC to expect to receive the data from the first APD.

18. The computer system of claim 10, wherein the first APD is configured to improve networking-related performance by:
improving performance of the first APD, wherein the first APD is communicatively coupled to a first NIC, a second APD is communicatively coupled to a second NIC, and the first APD is communicatively coupled to the second APD through the first NIC and the second NIC,
wherein the network command comprises a network receive command to receive data at the first APD from the second APD, and
wherein improving performance of the first APD comprises increasing execution priority of work on the second APD related to sending the data that is to be received at the first APD.

19. A distributed computing system for improving network-related performance for accelerated processing devices (“APDs”), the distributed computing system comprising:
a first computing system including a first network interface controller (“NIC”), and a first APD; and
a second computing system including a second NIC and a second APD, the second NIC being communicatively coupled to the first NIC,
wherein the first APD is configured to:
predict that a networking command is to be executed on a first APD for the first NIC; and
responsive to the predicting, performing one or more operations to improve networking-related performance.

20. The distributed computing system of claim 19, wherein the first APD is configured to predict that the networking command is to be executed on the first APD by performing one or more of:
detecting activation of a first APD command queue;
detecting scheduling of a networking command on the first APD; or
executing a command on the first APD explicitly indicating that the networking command is to be executed; and
the first APD is configured to improve networking-related performance by performing one or more of:
improving performance of the first NIC;
triggering pre-fetch of network queue metadata into hardware slots of the first NIC; or
improve performance of the second APD.
